(19) United States
(12) Patent Application Publication
(10) Pub. No.: US 2024/0101074 A1
(43) Pub. Date: Mar. 28, 2024

(54) DEVICE, SYSTEM, AND METHOD FOR COLLECTING PARTICULATE MATTER FROM A MOTORIZED VEHICLE

(71) Applicant: Nicholas J. Singer, Irvine, CA (US)

(72) Inventor: Nicholas J. Singer, Irvine, CA (US)

(21) Appl. No.: 18/473,025

(22) Filed: Sep. 22, 2023

Related U.S. Application Data
(60) Provisional application No. 63/376,605, filed on Sep. 22, 2022.

(51) Int. Cl. B60S 1/68; B08B 5/04

(52) U.S. Cl. CPC B60S 1/68; B08B 5/04

(57) ABSTRACT

A system for collecting particulate matter includes a central module configured to be arranged in a motorized vehicle to collect particulate matter from a tire of the motorized vehicle. The central module includes a motor configured to provide suction. A collection tank receives the particulate matter from the tire of the motorized vehicle. The suction provided by the motor draws the particulate matter from the tire of the motorized vehicle into the collection tank. A control module is configured to regulate the suction provided by the motor. Collection heads are arranged about the motorized vehicle to receive the particulate matter from the tire of the motorized vehicle. Conduits connect the collection heads with the collection tank to convey the particulate matter received at the collection heads to the collection tank.

### CROSS-REFERENCE TO RELATED APPLICATIONS

This application claims the benefit of priority to U.S. Patent Provisional Application No. 63/376,605, filed on 2022 Sep. 22, the entire contents of which are expressly incorporated herein by reference.

### STATEMENT RE: FEDERALLY SPONSORED RESEARCH/DEVELOPMENT

Not Applicable.

### FIELD

The present disclosure relates to collecting particulate matter and, more particularly, to a device, system, and method for collecting particulate matter from a motorized vehicle.

### BACKGROUND

A tire is a circular-shaped component surrounding a wheel's rim. Tires can be employed to transfer a vehicle's load from its axle through the wheel and to the ground to provide traction on the surface over which the wheel travels. Tires may be formed of rubber or a rubber/composite compound to provide a desired level of traction for the wheel. However, during use, particles can be released from tires that may cause air, water, or soil pollution.

### SUMMARY

Provided in accordance with aspects of the present disclosure is a system for collecting particulate matter including a central module configured to be arranged in a motorized vehicle to collect particulate matter from a tire of the motorized vehicle. The central module includes a motor configured to provide suction. A collection tank receives the particulate matter from the tire of the motorized vehicle. The suction provided by the motor draws the particulate matter from the tire of the motorized vehicle into the collection tank. A control module is configured to regulate the suction provided by the motor. Collection heads are arranged about the motorized vehicle to receive the particulate matter from the tire of the motorized vehicle. Conduits connect the collection heads with the collection tank to convey the particulate matter received at the collection heads to the collection tank.

In an aspect of the present disclosure, the collection heads are arranged in a wheel well of the motorized vehicle.

In an aspect of the present disclosure, the collection heads are coupled with an axle of the motorized vehicle.

In an aspect of the present disclosure, a width of at least one collection head is at least as wide as a width of a tire of the motorized vehicle.

In an aspect of the present disclosure, at least one collection head defines a circular shape, an oval shape, a rectangular shape, a rhombus shape, a trapezoidal shape, a moon shape, or a duckbill shape.

In an aspect of the present disclosure, a control valve is in communication with the conduits. The control valve regulates an amount of suction pressure applied to at least one collection head.

In an aspect of the present disclosure, the control module is configured to individually regulate an amount of suction pressure applied at each collection head.

In an aspect of the present disclosure, the control module is configured to apply a first amount of suction pressure to a first pair of collection heads arranged at a corresponding pair of front wheels of the motorized vehicle and a second amount of suction pressure to a second pair of collection heads arranged at a corresponding pair of rear wheels of the motorized vehicle. The first amount of suction pressure is different from the second amount of suction pressure.

In an aspect of the present disclosure, the control module is configured to apply a first amount of suction pressure to a first pair of collection heads arranged at a corresponding pair of left side wheels of the motorized vehicle and a second amount of suction pressure to a second pair of collection heads arranged at a corresponding pair of right side wheels of the motorized vehicle. The first amount of suction pressure is different from the second amount of suction pressure.

In an aspect of the present disclosure, the control module is configured to regulate the amount of suction pressure applied at each collection head based on a detected set of road conditions experienced by each wheel of the motorized vehicle.

In an aspect of the present disclosure, at least one sensor is configured to detect the set of road conditions.

In an aspect of the present disclosure, the road condition sensor is an optical sensor.

In an aspect of the present disclosure, the control module is configured to regulate the amount of suction pressure applied at each collection head based on a detected amount of particulate matter generated by each wheel of the motorized vehicle.

In an aspect of the present disclosure, at least one sensor is configured to detect the amount of particulate matter generated by each wheel of the motorized vehicle.

In an aspect of the present disclosure, the particulate matter sensor is an optical sensor.

In an aspect of the present disclosure, the control module is configured to regulate the amount of suction pressure applied at each collection head based on an amount of power applied to each wheel of the motorized vehicle.

In an aspect of the present disclosure, a filter is in communication with at least one collection head. The filter is configured to pass the particulate matter into at least one conduit and block debris larger than the particulate matter from passing into the at least one conduit.

In an aspect of the present disclosure, the system for collecting particulate matter is factory-installed in a motorized vehicle.

In an aspect of the present disclosure, a motorized vehicle is retrofitted to add the system for collecting particulate matter.

### BRIEF DESCRIPTION OF THE DRAWINGS

Various aspects and features of the present disclosure are described hereinbelow with reference to the drawings wherein:

FIG. 1 is a side view of a system for collecting particulate matter according to aspects of the present disclosure;

FIG. 2 is a perspective view of a system for collecting particulate matter according to aspects of the present disclosure;

FIG. 3 is a schematic view of a system for collecting particulate matter according to aspects of the present disclosure;

FIG. 4 is a side view of a wheel well of a motorized vehicle including sensors arranged about the wheel well according to aspects of the present disclosure;

FIG. 5 is a side view of a wheel well of a motorized vehicle including exemplary positions for collection heads about the wheel well according to aspects of the present disclosure;

FIG. 6 is a top plan, schematic view illustrating collection heads arranged about axles of a motorized vehicle according to aspects of the present disclosure;

FIGS. 7-11 are flow charts of a method of selectively applying suction pressure to a set of collection heads according to aspects of the present disclosure;

FIG. 12 is a schematic view of a filter arranged in a conduit according to aspects of the present disclosure;

FIG. 13 is a schematic view of a filter arranged about a collection head according to aspects of the present disclosure;

FIG. 14 is a schematic view of a filter arranged in a conduit adjacent another collection head according to aspects of the present disclosure;

FIG. 15 is a schematic view of a filter arranged about another collection head according to aspects of the present disclosure; and

FIG. 16 is a block diagram of an exemplary computer employable by the device, system, and method described herein according to aspects of the present disclosure.

### DETAILED DESCRIPTION

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Exemplary configurations of the disclosure will be described more fully below (e.g., with reference to the accompanying drawings) Like reference numerals may refer to like elements throughout the specification and drawings.

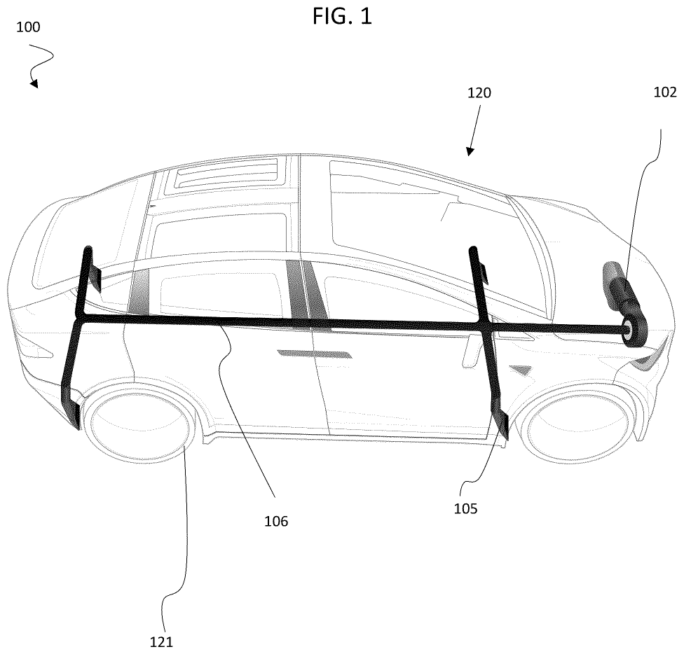

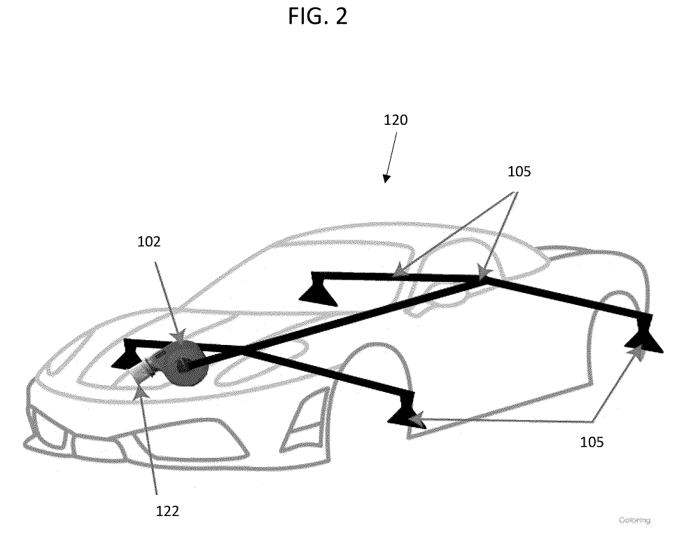

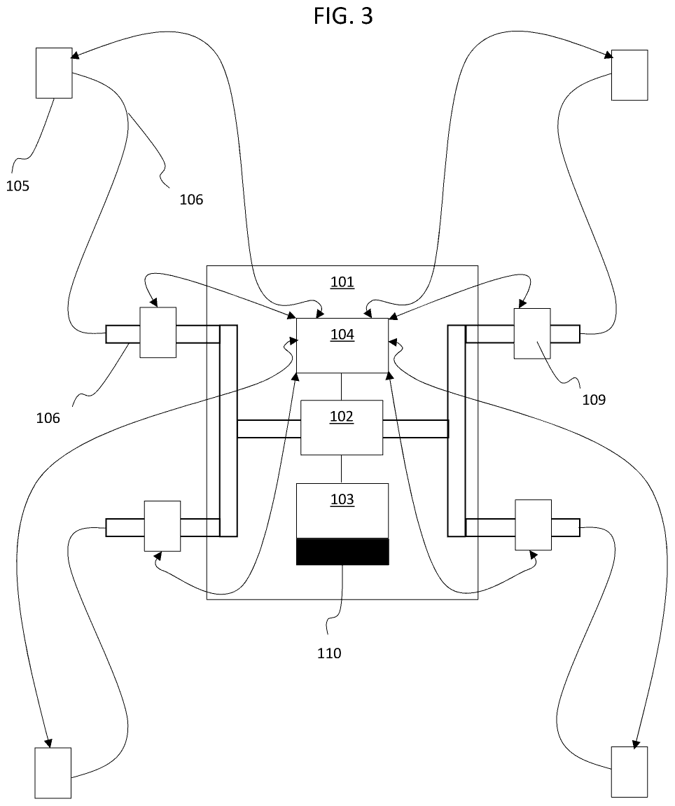

Referring generally to FIGS. 1 and 2, a system 100 for collecting particulate matter includes a motor 102 configured to provide suction to a number of collection heads 105 through a series of conduits 106 connecting the collection heads 105 with the motor 102. The motor 102 may include and may drive a pump to generate suction. The motor 102 may receive electrical energy to power the pump to generate suction pressure. The motor 102 may be a suction motor that creates vacuum pressure (i.e., suction) directly, or the motor 102 may operate by driving the pump to create suction. The motor 102 may include a filtered exhaust 122. The collection heads 105 are arranged to be adjacent the tires 121 of a motorized vehicle 120 to collect particulate matter released from the tires 121, such as while the motorized vehicle 120 is in motion. By applying suction from the motor 102, through the conduits 106, and to the collection heads 105, a continuous airflow from the tires 121 of the motorized vehicle 120 and into the collection heads 105 is created to draw any released particulate matter from the tires 121 and into the collection heads 105. The particulate matter is pulled into a corresponding collection head 105, through the conduits 106 and into a collection chamber or collection tank (see, e.g., the collection tank 103 in FIG. 3, and described in more detail below) by the suction applied by the motor 102. As an example, a suction pump connected with the conduits 106 may be driven by a motor and/or battery of the motorized vehicle.

The conduits 106 may include polyvinyl chloride (PVC), plastic, a composite, or a metal.

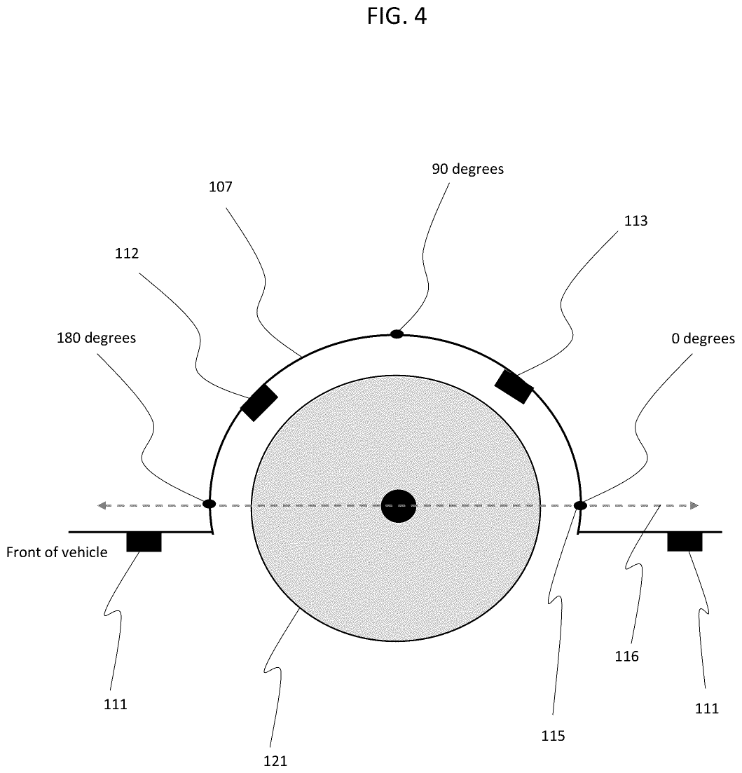

The flow of suction can be continuously and dynamically provided to the collection heads 105 while the motorized vehicle 120 is in use and/or while the motorized vehicle 120 is stationary or not in use to maximize the removal of particulate matter released by the tires 121 of the motorized vehicle 120. As an example, the collection heads 105 may be arranged behind each tire 121 of the motor vehicle 120, such as by molding the collection heads 105 into a wheel well 107 (see, e.g., FIG. 4) or a mud flap of the motorized vehicle 120.

Particulate matter released from tires 121 may include any component, material, or chemical used in forming a tire, such as microplastic or nanoplastic materials. As an example, such particulate matter may be sufficiently small and light to become at least temporarily airborne. The particulate matter may include tire and road wear particles (TRWP). TRWP can include debris released from a tire, debris released from a roadway, or a combination of debris from a tire and debris from a roadway. Particulate matter may include rubber, such as synthetic rubber formed from crude oil, used for forming tires.

The motorized vehicle 120 could be any sort of vehicle having wheels and tires. For example, the motorized vehicle 120 may be a car, truck, or SUV, such as an electric, hybrid, or plug-in hybrid car, truck, or SUV. The motorized vehicle 120 could also be a bus, van, motorcycle, scooter, or golf cart.

Referring particularly to FIG. 3, the system for collecting particulate matter 100 includes a central module 101 configured to be arranged in the motorized vehicle 120 to collect particulate matter from the tire 121 of the motorized vehicle 120. The central module 101 includes a pump and/or motor 102 configured to provide suction. A control module 104 is configured to regulate the suction provided by the motor 102. The control module 104 may be a separate computer device, or an onboard computer of the motorized vehicle 120 may be employed to operate as the control module 104. The control module 104 may also be in data/electrical communication with an onboard computer of the motorized vehicle 120.

Collection heads 105 are arranged about the motorized vehicle 120 to receive the particulate matter from the tires 121 of the motorized vehicle 120. Conduits 106 connect the collection heads 105 with the collection tank 103 to convey the particulate matter received at the collection heads 105 to the collection tank 103. At least one collection head 105 may be positioned adjacent each tire 121 of the motorized vehicle 120 to draw any particulate matter released by the tire 121 or generated from contact between the tire 121 and a roadway through the collection head 105 and into the conduit 106 through the action of suction applied by the motor 102 to the collection head 105.

In an aspect of the present disclosure, at least one collection head 105 defines a circular shape, an oval shape, a rectangular shape, a rhombus shape, a trapezoidal shape, a moon shape, or a duckbill shape.

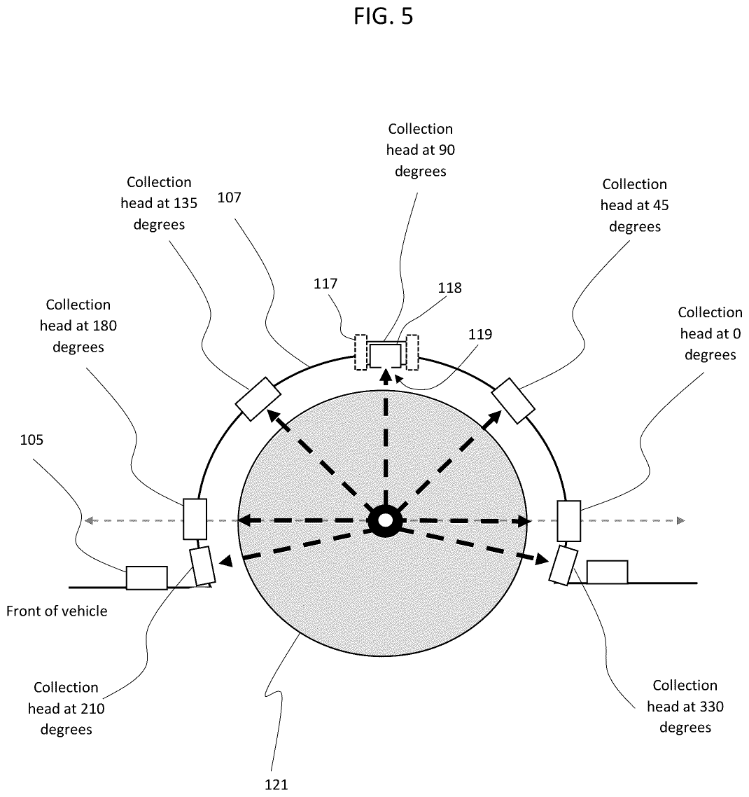

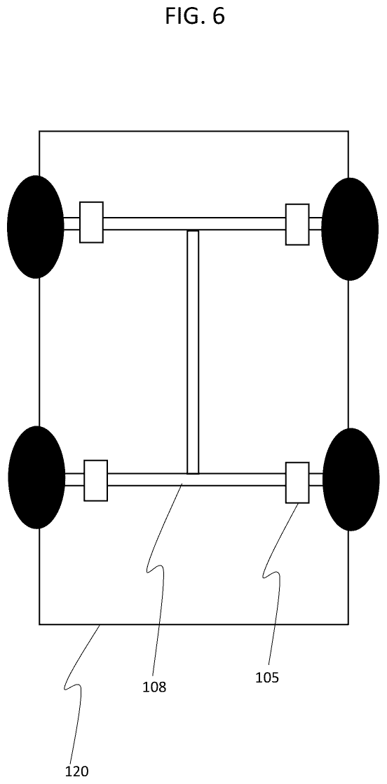

As an example, the collection heads 105 are arranged in the wheel well 107 of the motorized vehicle 120 (see, e.g., FIGS. 4 and 5). Alternatively, or in addition to a position in the wheel well 107 of the motorized vehicle 120, the collection heads 105 may be coupled with an axle 108 of the motorized vehicle 120 (see, e.g., FIG. 6).

Referring particularly to FIGS. 4 and 5, a location of the collection heads 105 around the wheel well 107 may be determined with respect to a reference point 115 located at an intersection between a horizontal central axis 116 of the wheel of the motorized vehicle 120 and the wheel well 107 of the motorized vehicle 120 (see, e.g., the reference point 115 in FIG. 4). The reference point 115 may be defined as 0 degrees with respect to a 360-degree rotational orientation of the wheel. Drawing axes from the center of the wheel until each of these axes crosses the wheel well 107 defines various rotational points about the wheel well 107. For example, a point on the wheel well 107 directly opposite the reference point 115 (i.e., 0 degrees) would have a rotational orientation of 180 degrees along the wheel well 107. Similarly, a vertical axis extending from the wheel 107 would define a 90-degree rotational orientation around the wheel well 107 (see collection head 105 at 90 degrees in FIG. 5).

Each wheel well 107 of the motorized vehicle 120 may include a single collection head 105, or multiple collection heads 105.

As an example, each wheel well 107 may include a collection head 105 at the zero-degree point of each wheel well 107 of the motorized vehicle 120.

The motorized vehicle 120 may include at least one downward facing collection head 105 (see, e.g., downward facing collection head in FIG. 5).

The position of each collection head 105 may be determined based on a distance from the tire 121 of the motorized vehicle 120. For example, each collection head 105 may be recessed or projected with respect to the wheel well 107 to maintain a predetermined distance between the collection head 105 and the wheel well 107. This allows a desired amount of air pressure and air flow to be maintained between the tire 121 and the collection head 105. As an example, the specific position of the collection head 105 may be adjusted to account for tire wear over time, or for changing the tires on a motorized vehicle 120 to tires of different thicknesses.

Each collection head 105 may include a track 117 configured to advance or retract the collection head 105 to adjust a distance of the collection head 105 from the tire 121 of the motorized vehicle 120. The collection head 105 may be advanced manually or by a motor configured to move the collection head 105 along the track 117.

The collection heads 105 may include a retractable sleeve 118 configured to be advanced toward or away from the tire 121 of the motorized vehicle 120 to regulate a distance between the collection heads 105 and the tire 121.

The collection heads 105 may include an aperture 119, such as an adjustable aperture for regulating an amount of suction pressure between the tire 121 and the collection heads 105. The size of the aperture 119 may be adjusted by the control module 104, which is in electrical communication with the collection heads 105.

The position of the collection head 105 (e.g., about the wheel well 107 or the axle 108) can be adjusted with respect to a road surface. For example, a location of the collection heads 105 can be adjusted to a predetermined height above a road surface on which the motorized vehicle 120 is traveling or expected to be traveling.

As an example, a width of at least one collection head 105 is at least as wide as a width of the tire 121 of the motorized vehicle 120. Alternatively, the width of the collection head 105 may be smaller than the width of the tire 121. For example, the width of the collection head 105 may be 10% of a width of the tire 121 or greater.

Referring particularly to FIG. 3, the collection tank 103 receives the particulate matter from the tire 121 of the motorized vehicle 120. The suction provided by the motor 102 draws the particulate matter from the tire 121 of the motorized vehicle 120 into the collection tank 103 after the particulate matter passes through the collection heads 105 and the corresponding conduits 106.

The collection tank 103 may include a filter 110 configured to capture relatively small particles, such as airborne particles, to prevent the relatively small particles from exiting the collection tank 103. As an example, an airborne particle may be less than 10 microns, such as a particle that is 1 micron or less. A micron is a unit of measurement that is short for a micrometer or one-millionth of a meter. Micron measurements can be used to determine a size of particulate matter.

A method of selectively regulating a flow of pressure to each collection head 105 using the device and system described herein is described in more detail below with reference to FIGS. 3 and 7-11.

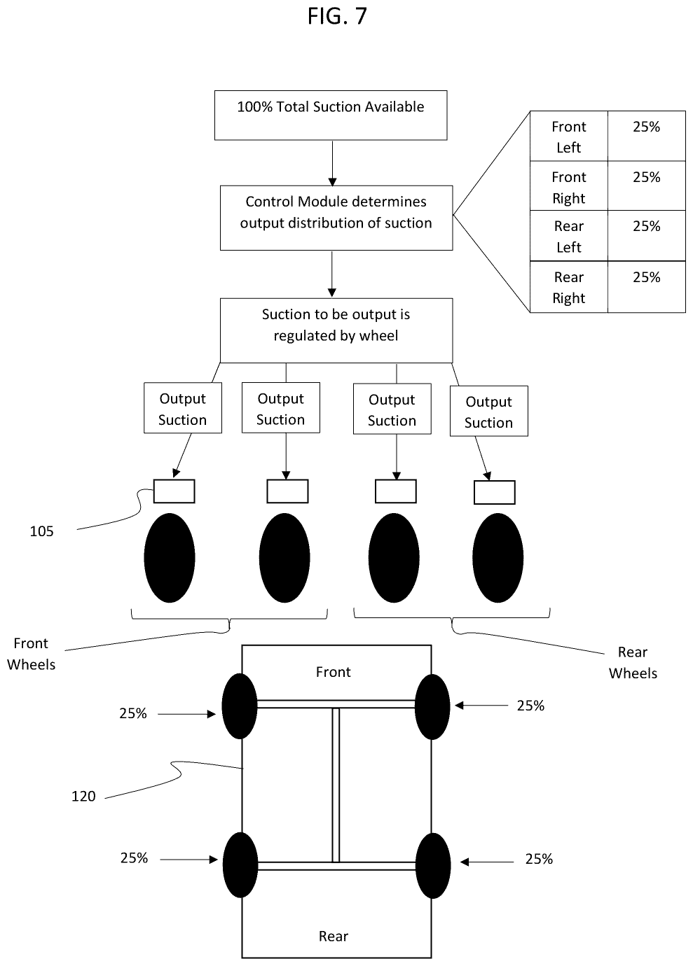

Referring to FIGS. 3 and 7-11, a control valve 109 (e.g., a pressure control valve) is in communication with the conduits 106 connected with each of the collection heads 105. The control valve 109 can be employed to regulate an amount of suction pressure applied to at least one collection head 105 by regulating an amount of pressure passed through each section of conduit 106. The control module 104 can individually regulate an amount of suction pressure applied at each collection head 105 by controlling the control valves 109. The control valves 109 can be employed to regulate how a total amount of output pressure from the motor 102 is distributed. For example, considering a total available suction of 100%, the suction can be distributed evenly to each tire (25% suction per tire—see, e.g., FIG. 7), or the amount of suction may be varied (see, e.g., FIGS. 8-11). The total amount of output pressure from the motor 102 can also be regulated by the control module 104. As an example, the revolutions per minute (RPMs) of the motor 102 may be adjusted to control an amount of raw suction pressure output by the motor 102. As an example, the motor 102 may be configured to operate at up to, at least, 10,000 RPM, or from about 10 RPM to about 10,000 RPM. Suction pressure can also be measured as negative pounds per square inch (PSI). As an example, the suction pressure generated by the motor 102 may be up to, at least, 30 PSI.

As an example, the control valves 109 may include a relief valve, a reduce valve, a sequence valve, a counterbalance valve, a safety valve, or an unloading valve.

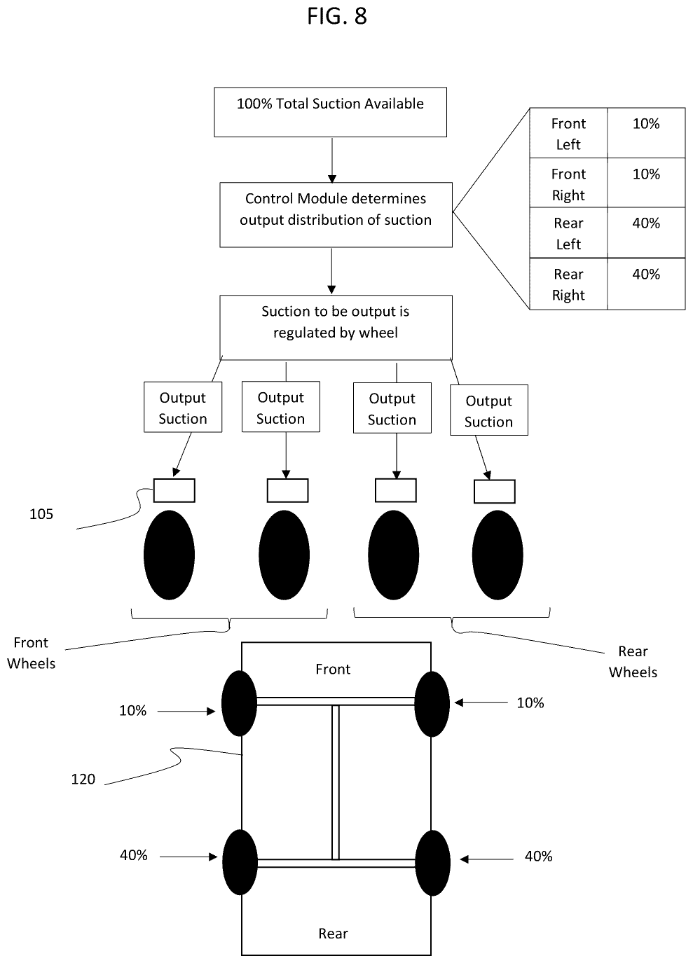

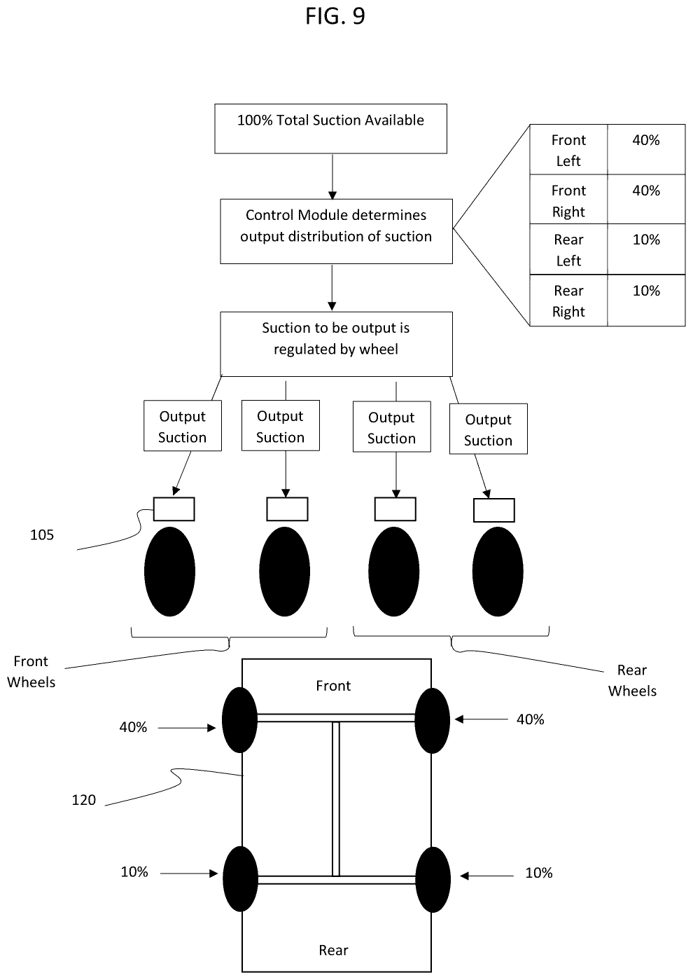

Referring particularly to FIGS. 8 and 9, the control module 104 can be configured to apply a first amount of suction pressure to a first pair of collection heads 105 arranged at a corresponding pair of front wheels of the motorized vehicle 120 and a second amount of suction pressure to a second pair of collection heads 105 arranged at a corresponding pair of rear wheels of the motorized vehicle 120. The first amount of suction pressure can be different from the second amount of suction pressure. For example, in a rear-wheel-drive vehicle, the suction pressure to the rear wheels may be increased (see, e.g., FIG. 8). Alternatively, in a front-wheel-drive vehicle, the suction pressure to the front wheels may be increased (see, e.g., FIG. 9).

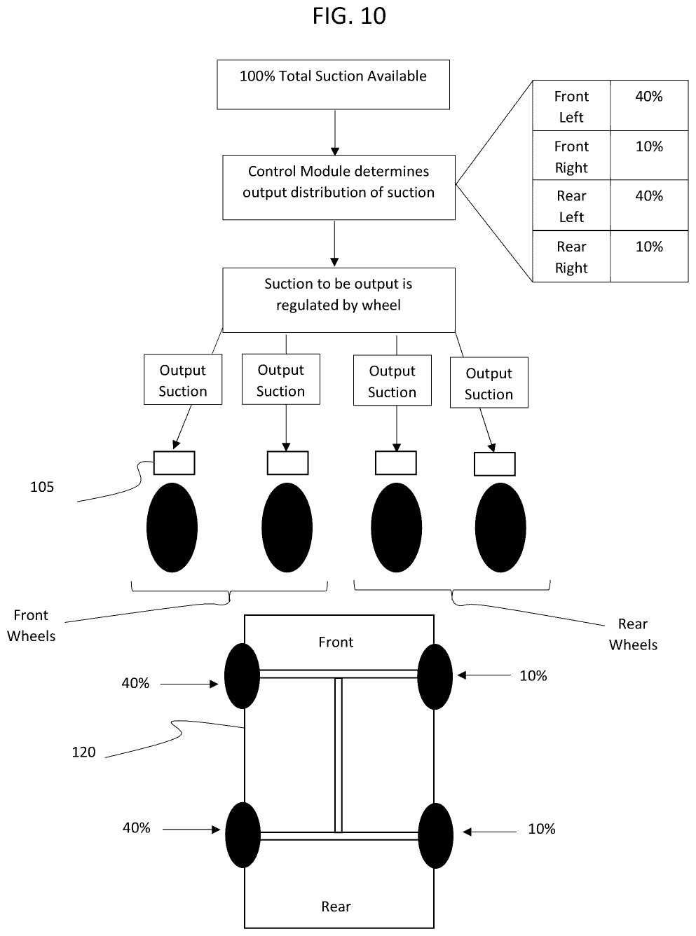

Referring particularly to FIG. 10, the control module 104 is configured to apply a first amount of suction pressure to a first pair of collection heads 105 arranged at a corresponding pair of left side wheels of the motorized vehicle 120 and a second amount of suction pressure to a second pair of collection heads 105 arranged at a corresponding pair of right side wheels of the motorized vehicle 120. The first amount of suction pressure is different from the second amount of suction pressure.

For example, an increased amount of suction pressure may be applied to the left side wheels based on a detected set of road conditions experienced by each wheel of the motorized vehicle 120.

Referring particularly to FIGS. 4 and 10, at least one sensor (e.g., a road condition sensor 111) is configured to detect the set of road conditions. The road condition sensor 111 is in electrical/data communication with the control module 104. As an example, the road condition sensor 111 may be arranged on a bottom surface of the motorized vehicle 120. The road condition sensor 111 may be an optical sensor, such as a point sensor or a distributed sensor. The road condition sensor 111 may include a camera configured to capture digital image data of the road conditions for communication to the control module 104.

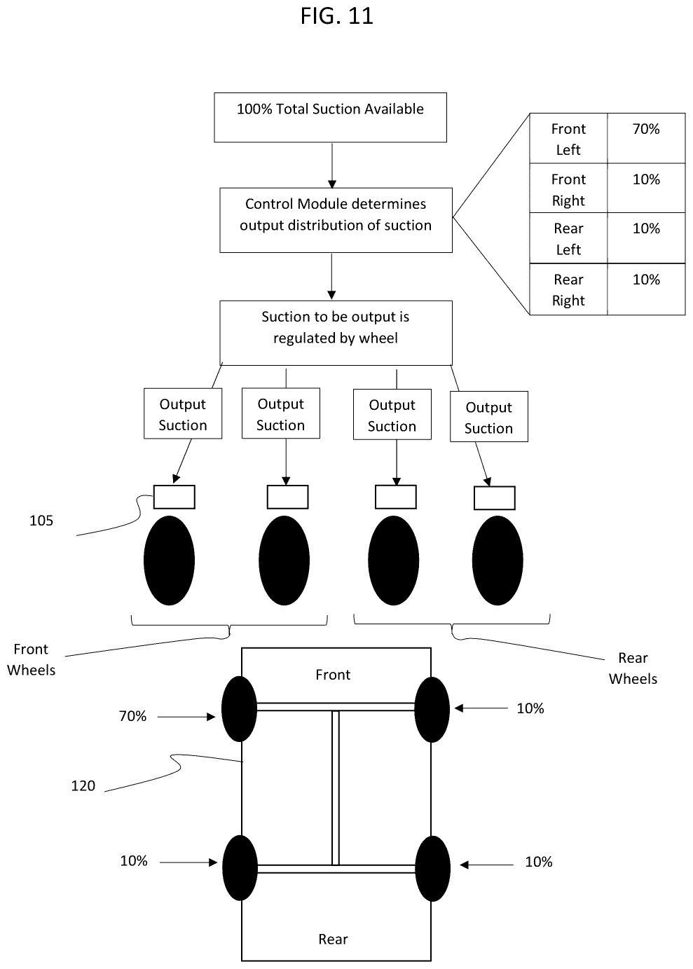

Referring particularly to FIG. 11, the control module 104 is configured to regulate the amount of suction pressure applied at each collection head 105 based on a detected amount of particulate matter generated by each wheel of the motorized vehicle 120. The control module 104 may determine the amount of particulate matter generated by each tire 121 of the motorized vehicle 120 by quantifying an amount or volume of detected particulate matter generated by each tire 121 and generating a weight of particulate matter per mile driven, or a number of particles per mile driven value for each tire 121. These values can be continuously determined and updated to calculate real-time tire wear and to dynamically allocate increased suction force to the tires displaying the greatest degree of wear.

Referring to FIGS. 4 and 11, the amount of particulate matter actually generated by each tire 121 can be actively determined by a sensor (e.g., a particulate matter sensor 112).

As an example, the particulate matter sensor 121 may be arranged on or in an inner surface of the wheel well 107 of the motorized vehicle 120. The particulate matter sensor 112 may be an optical sensor, such as a point sensor or a distributed sensor. The particulate matter sensor 112 may include a camera configured to capture digital image data of the generated particulate matter for communication to the control module 104.

As an example, the particulate matter sensor 112 may be arranged on a bottom surface of the motorized vehicle 120. The particulate matter sensor 112 may be an optical sensor, such as a point sensor or a distributed sensor. The particulate matter sensor 112 may include a camera configured to capture digital image data of the road conditions for communication to the control module 104.

Referring particularly to FIG. 4, the amount of suction applied to a particular tire 121 may also be determined based on tire condition. A tire 121 showing an increased degree of wear can be identified by a sensor (e.g., a tire condition sensor 113 arranged in or on the inner surface of the wheel well 107 of the motorized vehicle 120). The condition of the tire 121 can be communicated to the control module 104 and increased suction pressure can be applied to tires 121 showing increased wear.

As an example, the tire condition sensor 113 may be an optical sensor, such as a point sensor or a distributed sensor. The tire condition sensor 113 may include a camera configured to capture digital image data of the tire condition for communication to the control module 104.

In an aspect of the present disclosure, the control module 104 is configured to regulate the amount of suction pressure applied at each collection head 105 based on an amount of power applied to each wheel of the motorized vehicle 120, such as in an all-wheel-drive vehicle in which power can be selectively and dynamically applied to each wheel. As an example, wheels receiving increased power relative to the other wheels may receive increased suction pressure (e.g., during the time period in which the increased power is applied). In a situation in which increased power is applied to a particular wheel, the amount of suction pressure to that wheel can be increased for a limited period of time (e.g., during the application of the increased pressure and for a predetermined time period after normal power allocation has been restored to the wheels).

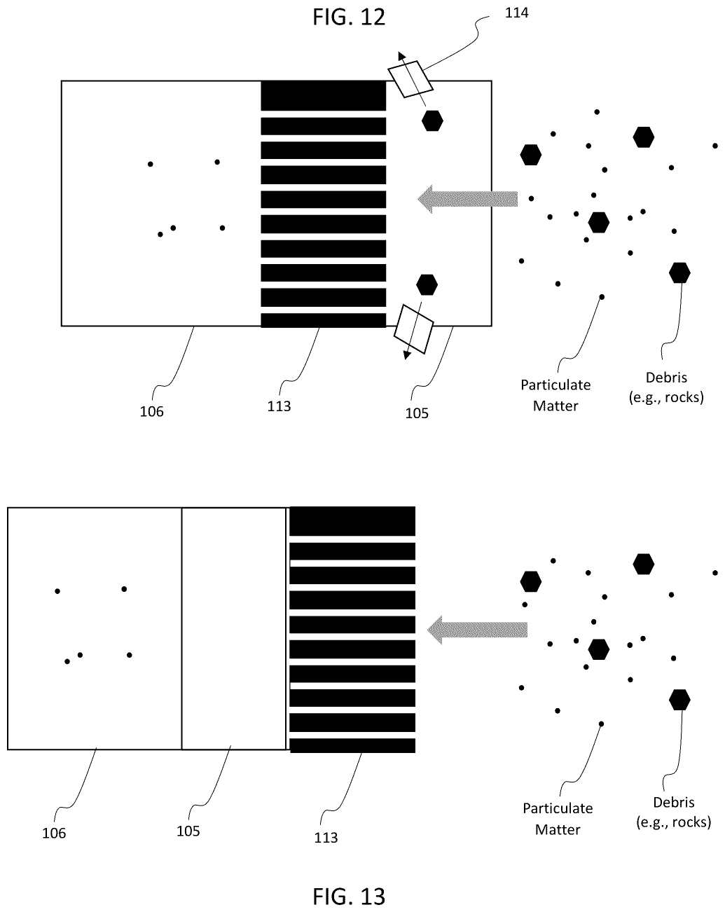

Referring to FIGS. 12-15, a filter 113 is in communication (e.g., in fluid communication) with at least one collection head 105. The filter 113 is configured to pass the particulate matter into at least one conduit 106 and block debris larger than the particulate matter from passing into the at least one conduit 106. The filter 113 can be employed to selectively allow the desired particulate matter to be collected while blocking debris, such as rocks, from entering the system for collecting particulate matter 100.

The filter 113 may be a micron-scale (a micron is a unit of measurement that is short for a micrometer or one-millionth of a meter) air filter configured to remove particles of a predetermined micron scale.

Referring particularly to FIG. 12, the filter 113 may be arranged in a conduit 106 and may include at least one diverter 114 to remove unwanted debris (e.g., rocks) from the system 100 while allowing the desired particulate matter to pass through the filter 113.

Referring particularly to FIG. 13, the filter 113 may be arranged on a distal end portion of the collection head 105 to prevent the debris from entering the collection head 105, while allowing the desired particulate matter to pass into the collection head 105.

Referring particularly to FIG. 14, the collection head 105 may have a shape defining a wider distal end and a narrower proximal end. As an example, the collection head 105 may have a duckbill shape.

The filter 113 may be arranged in the conduit 106 on a proximal side of the collection head 105, and a diverter 114 may direct debris (e.g., rocks) out of the collection head 105.

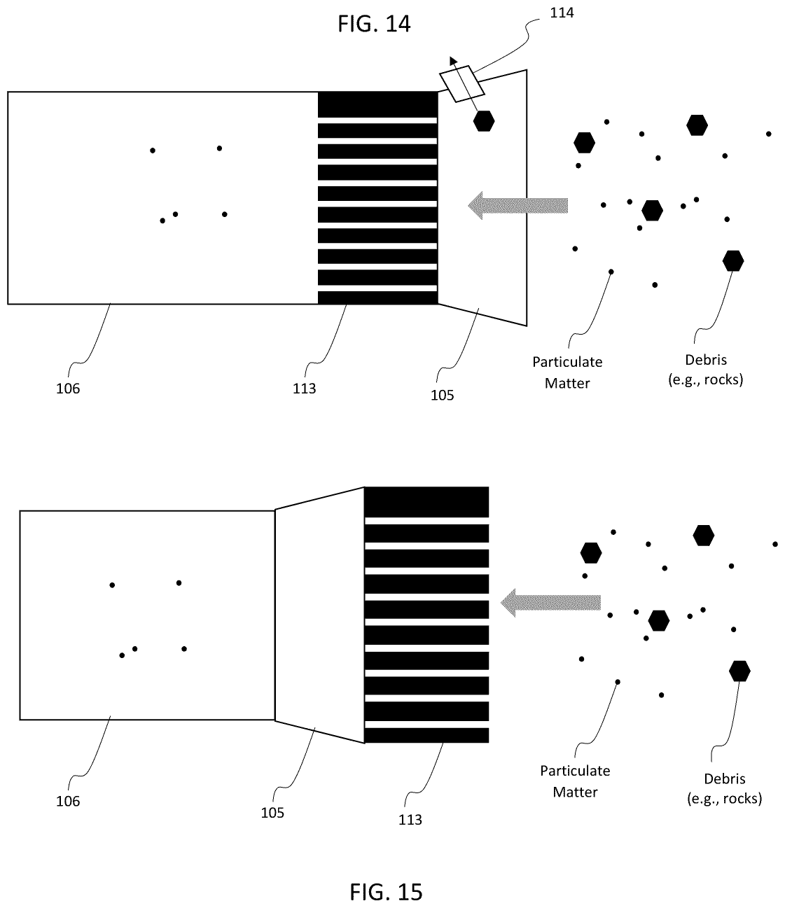

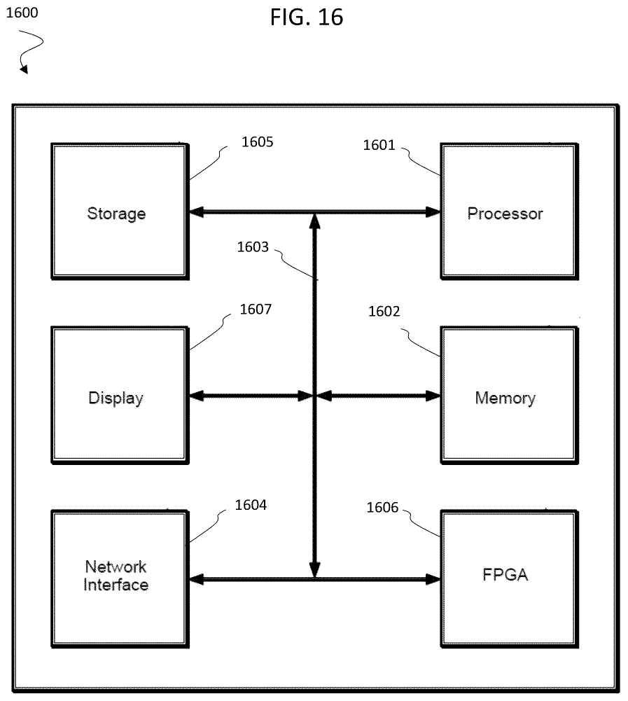

Referring particularly to FIG. 15, the collection head 105 having the wider distal end may include the filter 113 on a distal side of the collection head 105 to prevent debris (e.g., rocks) from entering the collection head 105, while allowing the desired particulate matter to pass into the collection head 105 and in the connected conduit 106.

In an aspect of the present disclosure, the system for collecting particulate matter 100 is factory-installed in a motorized vehicle.

In an aspect of the present disclosure, a motorized vehicle is retrofitted to add the system for collecting particulate matter 100.

Referring to FIG. 16, a general-purpose computer 1600 employable by the control module 104 is described. The general-purpose computer 1600 can be employed by the devices, systems and methods described herein to perform the various methods and algorithms described herein. The computer 1600 may include a processor 1601 connected to a computer-readable storage medium or a memory 1602 which may be a volatile type memory, e.g., RAM, or a non-volatile type memory, e.g., flash media, disk media, etc. The processor 1601 may be another type of processor such as, without limitation, a digital signal processor, a microprocessor, an ASIC, a graphics processing unit (GPU), field-programmable gate array (FPGA), or a central processing unit (CPU).

In some aspects of the disclosure, the memory 1602 can be random access memory, read-only memory, magnetic disk memory, solid state memory, optical disc memory, and/or another type of memory. The memory 1602 can communicate with the processor 1601 through communication buses 1603 of a circuit board and/or through communication cables such as serial ATA cables or other types of cables. The memory 1602 includes computer-readable instructions that are executable by the processor 1601 to operate the computer 1600 to execute the algorithms described herein. The computer 1600 may include a network interface 1604 to communicate (e.g., through a wired or wireless connection) with other computers or a server. A storage device 1605 may be used for storing data. The computer 1600 may include one or more FPGAs 1606. The FPGAs 1606 may be used for executing various machine learning algorithms. A display 1607 may be employed to display data processed by the computer 1600.

The electrical/data connections between the control module 104 and the various components described herein may be made through wired or wireless connections (e.g., short range wireless connections). For example, the wireless connections may be made by Bluetooth or other radio frequency connections.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

What is claimed is:

1. A system for collecting particulate matter, comprising:
a central module configured to be arranged in a motorized vehicle to collect particulate matter from at least one tire of the motorized vehicle, the central module including:
at least one motor configured to provide suction;
at least one collection tank configured to receive the particulate matter from the at least one tire of the motorized vehicle, wherein the suction provided by the at least one motor draws the particulate matter from the at least one tire of the motorized vehicle into the at least one collection tank; and
a control module configured to regulate the suction provided by the at least one motor;
a plurality of collection heads configured to be arranged about the motorized vehicle to receive the particulate matter from the at least one tire of the motorized vehicle; and
a plurality of conduits configured to connect the collection heads of the plurality of collection heads with the at least one collection tank to convey the particulate matter received at the collection heads of the plurality of collection heads to the collection tank.

2. The system of claim 1, wherein the collection heads of the plurality of collection heads are configured to be arranged in a wheel well of the motorized vehicle.

3. The system of claim 1, wherein the collection heads of the plurality of collection heads are configured to be coupled with an axle of the motorized vehicle.

4. The system of claim 1, wherein a width of at least one collection head of the plurality of collection heads is at least as wide as a width of the at least one tire of the motorized vehicle.

5. The system of claim 1, wherein at least one collection head of the plurality of collection heads defines a circular shape, an oval shape, a rectangular shape, a rhombus shape, a trapezoidal shape, a moon shape, or a duckbill shape.

6. The system of claim 1, further including at least one control valve in communication with the plurality of conduits, wherein the at least one control valve regulates an amount of suction pressure applied to at least one collection head of the plurality of collection heads.

7. The system of claim 1, wherein the control module is configured to individually regulate an amount of suction pressure applied at each collection head of the plurality of collection heads.

8. The system of claim 7, wherein the control module is configured to apply a first amount of suction pressure to a first pair of collection heads arranged at a corresponding pair of front wheels of the motorized vehicle and a second amount of suction pressure to a second pair of collection heads arranged at a corresponding pair of rear wheels of the motorized vehicle, and wherein the first amount of suction pressure is different from the second amount of suction pressure.

9. The system of claim 7, wherein the control module is configured to apply a first amount of suction pressure to a first pair of collection heads arranged at a corresponding pair of left side wheels of the motorized vehicle and a second amount of suction pressure to a second pair of collection heads arranged at a corresponding pair of right side wheels of the motorized vehicle, and wherein the first amount of suction pressure is different from the second amount of suction pressure.

10. The system of claim 7, wherein the control module is configured to regulate the amount of suction pressure applied at each collection head of the plurality of collection heads based on a detected set of road conditions experienced by each wheel of the motorized vehicle associated with each collection head of the plurality of collection heads.

11. The system of claim 10, further including at least one sensor configured to detect the set of road conditions.

12. The system of claim 11, wherein the sensor is an optical sensor.

13. The system of claim 7, wherein the control module is configured to regulate the amount of suction pressure applied at each collection head of the plurality of collection heads based on a detected amount of particulate matter generated by each wheel of the motorized vehicle associated with each collection head of the plurality of collection heads.

14. The system of claim 13, wherein at least one sensor is configured to detect the amount of particulate matter generated by each wheel of the motorized vehicle.

15. The system of claim 14, wherein the sensor is an optical sensor.

16. The system of claim 7, wherein the control module is configured to regulate the amount of suction pressure applied at each collection head of the plurality of collection heads based on an amount of power applied to each wheel of the motorized vehicle associated with each collection head of the plurality of collection heads.

18. The system of claim 1, further including a filter in communication with at least one collection head of the plurality of collection heads, wherein the filter is configured to pass the particulate matter into at least one conduit of the plurality of conduits and block debris larger than the particulate matter from passing into the at least one conduit of the plurality of conduits.

19. A system for collecting particulate matter, comprising:
a central module arranged in a motorized vehicle to collect particulate matter from at least one tire of the motorized vehicle, the central module including:
at least one motor configured to provide suction;
at least one collection tank configured to receive the particulate matter from the at least one tire of the motorized vehicle, wherein the suction provided by the at least one motor draws the particulate matter from the at least one tire of the motorized vehicle into the at least one collection tank; and
a control module configured to regulate the suction provided by the at least one motor;
a plurality of collection heads arranged about the motorized vehicle to receive the particulate matter from the at least one tire of the motorized vehicle; and
a plurality of conduits connecting the collection heads of the plurality of collection heads with the at least one collection tank to convey the particulate matter received at the collection heads of the plurality of collection heads to the collection tank.

20. A system for collecting particulate matter, comprising:
a central module configured to be arranged in a motorized vehicle to collect particulate matter from at least one tire of the motorized vehicle, the central module including:
at least one motor configured to provide suction; and
at least one collection tank configured to receive the particulate matter from the at least one tire of the motorized vehicle, wherein the suction provided by the at least one motor draws the particulate matter from the at least one tire of the motorized vehicle into the at least one collection tank;
a plurality of collection heads configured to be arranged about the motorized vehicle to receive the particulate matter from the at least one tire of the motorized vehicle; and
a plurality of conduits configured to connect the collection heads of the plurality of collection heads with the at least one collection tank to convey the particulate matter received at the collection heads of the plurality of collection heads to the collection tank.
